(19) United States
(12) Patent Application Publication
(10) Pub. No.: US 2018/0276213 A1
(43) Pub. Date: Sep. 27, 2018

(54) METHODS AND SYSTEM FOR DATABASE REQUEST MANAGEMENT

(71) Applicant: Home Depot Product Authority, LLC, Atlanta, GA (US)

(72) Inventors: Hari Ramamurthy, Marietta, GA (US); Murugan Gandhi, Smyrna, GA (US); Rageesh Thekkeyil, Cumming, GA (US); Kaustubh Kulkarni, Alpharetta, GA (US); Angie Brown, Atlanta, GA (US)

(21) Appl. No.: 15/470,310

(22) Filed: Mar. 27, 2017

(51) Int. Cl. G06F 17/30

(52) U.S. Cl. CPC G06F 17/3015; G06F 17/30377

(57) ABSTRACT

A database request management system in electronic communication with a database may be configured to compare new requests for data stored in the database to a registry of queued requests to determine if each new request is a duplicate of a queued request, reject duplicate requests, and add non-duplicate requests to a request queue and to a request registry. The request management system may also be configured to continuously transmit the top request from the queue of requests to the database, receive a response to the top request from the database, and remove the top request from the queue and unregister the top request from the request registry after receiving the response.

### FIELD OF THE DISCLOSURE

This disclosure is generally directed to database management, including the management of requests for information from a relational database storing an inventory of products.

### BACKGROUND OF RELATED ART

In many database applications, there are often concurrent requests for the same information stored in the database. For example, in multi-channel order management systems, there are often concurrent requests from client systems for the same order entity. Concurrent requests may also be an issue in other database contexts, such as a database storing policy information in an insurance context, a database storing bank account information in a banking context, etc. In certain scenarios, multiple requests for the same information may be proper, genuine requests. In other situations, multiple requests for the same information may be erroneous behavior due to, for example, a defect in the system that was the origin of one or more of the requests.

In the order management space, some databases manage concurrent requests with blocking locks with row-level pessimistic locking. Alternatively, some databases may apply an optimistic approach that may either compromise accuracy or may reject a transaction, which may result in some wasted database resources.

### SUMMARY

An example system may include a database request management system configured to be in electronic communication with a database, the database request management system comprising a non-transitory computer-readable program memory storing instructions, a non-transitory computer-readable data memory, and a processor configured to execute the instructions. The processor may execute the instructions to receive a new request for data stored in the database, determine that the database is busy processing a previous request for data stored in the database, store, in the data memory, the new request, receive, from the database, a response to the previous request, and in response to receiving the response to the previous request, transmit the new request to the database.

An example system may comprise a database request management system configured to be in electronic communication with a database, the database request management system comprising a non-transitory computer-readable program memory storing instructions, a non-transitory computer-readable data memory, and a processor configured to execute the instructions. The processor may execute the instructions to receive a plurality of requests for data stored in the database, compare each received request to requests that are registered in the data memory to determine, for each received request, if the received request is a duplicate of a request that is registered in the data memory, reject each received request that is determined to be a duplicate of a request that is registered in the data memory, register, in the data memory, each received request that is not determined to be a duplicate of a request that is registered in the data memory, and transmit each registered request to the database.

An example system may include a database and a database request management system in electronic communication with the database. The database request management system may include a non-transitory computer-readable program memory storing instructions, a non-transitory computer-readable data memory, the data memory storing a queue of requests for data from the database and a registry of queued requests, and a processor configured to execute the instructions. The processor may execute the instructions to (i) receive new requests for data stored in the database, (ii) compare each of the new requests to the registry of queued requests to determine if each new request is a duplicate of a queued request, (iii) reject each of the new requests that is a duplicate of a queued request, (iv) insert each new request that is not a duplicate request of a queued request in to the request queue, (v) register each new request that is not a duplicate request of a queued request in the registry, and (vi) in parallel with (i)-(v), continuously transmit the top request from the queue of requests to the database, receive a response to the top request from the database, and clear the top request from the queue and unregister the top request after receiving the response.

### BRIEF DESCRIPTION OF THE DRAWINGS

FIG. 1 is a diagrammatic view of a system for receiving and servicing requests for information from a database.

FIG. 2 is a sequence diagram illustrating an example native request management process for a database.

FIG. 3 is a flow chart illustrating an example method of managing duplicate requests for information from a database before the requests are submitted to the database.

FIG. 4 is a flow chart illustrating an example method of queuing requests for information stored in a database.

FIG. 5 is a sequence diagram illustrating a method of handling duplicate requests for information from a database with a database management system.

FIG. 6 is a sequence diagram illustrating a method of handling a queue of requests for information from a database with a database management system.

FIG. 7 is a sequence diagram illustrating a method of handling a queue of requests for information from a database with a database management system.

FIG. 8 is a diagrammatic view of an illustrative computing system that includes a general purpose computing system environment.

### DETAILED DESCRIPTION

In some embodiments, a database may be required to service a large number of requests. For example, a retail inventory database may be asked to service millions of order-related requests per hour. Thus, the misuse of database processing resources inherent in known approaches to concurrent orders and to order queuing can have a substantial effect on the performance of the database when considered on a large scale.

The present disclosure includes a database management system for managing requests for information stored in a database so as to improve upon native database request handling. The database management system may be provided as separate computing resources (i.e., separate processing and memory resources) from the database, and thus may enable the database to perform more efficiently and reliably, as will be described in greater detail below. Furthermore, a database management system according to the present disclosure may enable more efficient and reliable servicing of requests for information from the database.

A database management system according to the present disclosure may be provided between the database and the origins of requests for information from the database. That is, the database management system may receive requests for information, process those requests, and send those requests to the database as appropriate. Similarly, the database management system may receive responses to requests from the database and send those requests to the respective origins of the requests.

The instant disclosure will address embodiments in which the database is a non-relational, NOSQL database storing order records and inventory records respective of a plurality of products available for retail purchase. It should be understood, however, that such description is by way of example only. The methods, techniques, and other teachings of this disclosure may find use with databases in a wide variety of contexts. For example, as noted above, the present teachings may find use with databases in the insurance and banking contexts, as well as other contexts.

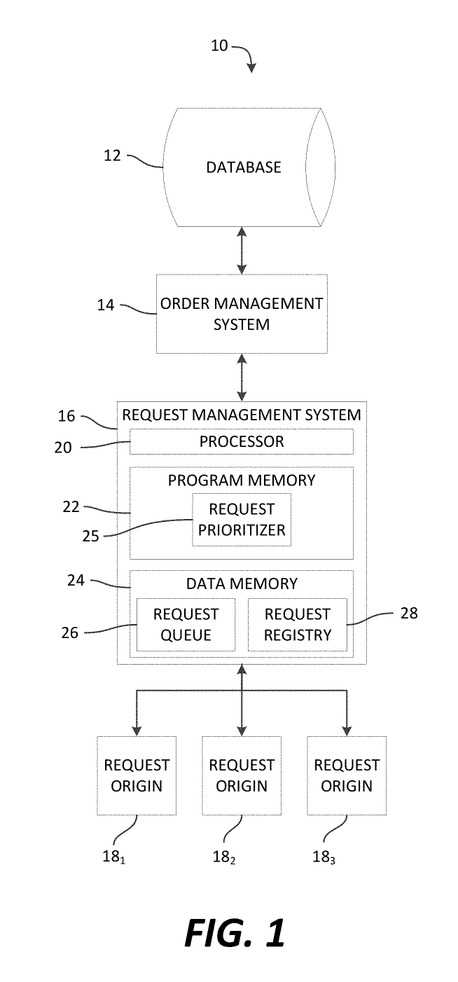

FIG. 1 is a diagrammatic view of a system 10 for receiving and servicing requests for information from a database. The system 10 may include a database 12, an order management system 14, a database request management system 16 (which may alternatively be referred to simply as a “request management system” 16), and a plurality of request origins 18₁, 18₂, . . . , 18_{N} (which may be referred to collectively as request origins 18 or individually as a request origin 18)

The database 12 may store records respective of orders for and inventory of a plurality of products available for retail purchase. For example, the database 12 may serve as the master inventory and order record for products available for purchase from a retailer in brick-and-mortar stores, on an e-commerce website, and/or through a mobile application, for example. The database 12 may be a non-relational database, in an embodiment. The database 12 may be a NOSQL database, in an embodiment.

As noted above, this disclosure will describe embodiments in which the database 12 stores records respective orders for and an inventory of a plurality of products available for retail purchase. In such an embodiment, the requests may be requests for information on past or in-process orders to purchase one or more products that are included in the inventory maintained by the database 12, for example.

The request origins 18 may be computing devices of end users, vendors that provide one or more products included in the database inventory, and/or other entities, in embodiments. The request origins 18 may send requests in order to determine the status of orders or modify orders represented in records in the database 12, for example, and/or any other purpose for which the data stored in the database may be used.

The order management system 14 may provide many functions involved in the placement, modification, and fulfillment of orders having records in the database 12. For example, the order management system 14 may track orders through the fulfillment process, may cancel and modify orders, may store, revise, and provide data necessary for shipping an order, may release ordered merchandise to the consumer, and may provide additional functions useful or necessary in the order placement and fulfillment process.

In an embodiment, the order management system 14 may be disposed between (in terms of communications) the request management system 16 and the database 12—i.e., the request management system 16 may achieve transmission of a request to the database 12 through the order management system 14, and may receive responses from the database 12 through the order management system 14. In another embodiment, the request management system 16 may communicate directly with the order management system 14 and the database 12 in parallel. In other embodiments, other or additional systems or sub-systems may be logically disposed between the request management system 16 and the database 12. In such embodiments, the request management system 16 may achieve communications with the database 12 through such other or additional systems or sub-systems. In other embodiments, the request management system 16 may communicate directly with the database 12.

In addition, as noted above, the teachings of the instant disclosure may find use in many database management contexts. Accordingly, in embodiments, the order management system 14 may be omitted.

The database request management system 16 may be in electronic communication with the order management system 14, with the database 12 (indirectly, through the order management system 14, in an embodiment, or directly, in other embodiments) and with the plurality of request origins 18. The request management system 16 may act as an intermediary between the origins 18 and the order management system 14 and the database 12 for servicing requests for information stored in the database 12 from the request origins 18. Accordingly, the request management system 16 may receive requests for information stored in the database 12 from the request origins 18, process those requests, and forward those requests to the order management system 14 and/or database 12 as appropriate, according to the teachings of this disclosure.

Just as communications between the request management system 16 and the database 12 may be direct or indirect, so too communications between the request management system 16 and the request origins 18 may be direct or indirect. In embodiments, communications between the request management system 16 and one or more of the request origins 18 may be through one or more servers or other systems or sub-systems.

The request management system 16 may include a processor 20, program memory 22, and data memory 24. The program memory 22 may store instructions that may be executed by the processor 20 to perform one or more of the methods, techniques, steps, etc. of this disclosure. A request prioritizer module 25 may be included in the program memory. The data memory 24 may include a request queue 26 and a request registry 28, in an embodiment.

The request queue 26 may include a set of requests that have not yet been responded to by the database 12. The requests stored in the queue 26 may include each complete request, in an embodiment. In an embodiment, the requests stored in the queue 26 may be arranged in or associated with a ranked order (e.g., from “top” to “bottom”), which ranked order may be used to sequentially provide requests to the database 12, as will be described in further detail below.

The request registry 28 may include identifiers respective of one or more requests. In an embodiment, the request registry 28 may include identifiers respective of one or more of the requests stored in the queue 26. In an embodiment, the request registry 28 may include identifiers respective of each request stored in the queue 26. The request identifiers that are stored in the registry 28 may be associated with each request before the requests reach the request management system 16, in an embodiment. As will be described in greater detail below, the request identifiers stored in the registry 28 may be used to quickly determine if a received request is a duplicate (which may have been sent in error) of another request that is already pending, in an embodiment. Request identifiers may be or may include, for example, order numbers assigned by the order management system 14, identifiers assigned by the order management system 14 to a set of multiple orders, or an email address of an entity that placed an order.

The request registry 28 and the request queue 26 may be implemented in the same physical memory device or devices, in an embodiment. Alternatively, the request registry 28 and the request queue 26 may be implemented in separate physical memory devices, in an embodiment. Furthermore, in an embodiment, the request registry 28 and/or the request queue 26 may be implemented in a memory structure that is physically separate from the primary computing resources of the request management system 16. For example, in an embodiment, the request registry 28 and/or the request queue 26 may be implemented in a database (separate from the database of FIG. 1) in electronic communication with the processor 20 of the request management system 16. In such an embodiment, for the purposes of this disclosure, a physically-separate request queue 26 and/or request registry 28 may be considered a part of the request management system 16.

Still further, in an embodiment, the order of the request queue 26—that is, the “top” to “bottom” ordering of queued requests—may be maintained in the request queue 26 itself. Additionally or alternatively, the order of the request queue 26 may be maintained in the request register 28 along with identifiers of the queued requests, in an embodiment, and/or in yet another memory portion. For ease of description, the remainder of the disclosure will discuss embodiments in which the order of the requests in the request queue 26 is maintained in the request queue 26 itself, but such description is by way of example only.

In embodiments, the request prioritizer may function as a control on the request queue. For example, in embodiments, the request prioritizer may organize or alter the order of requests in the request queue according to respective priorities associated with queued requests. Additionally or alternatively, the request prioritizer may select requests from the request queue for transmission to the database according to respective priorities associated with the queued requests.

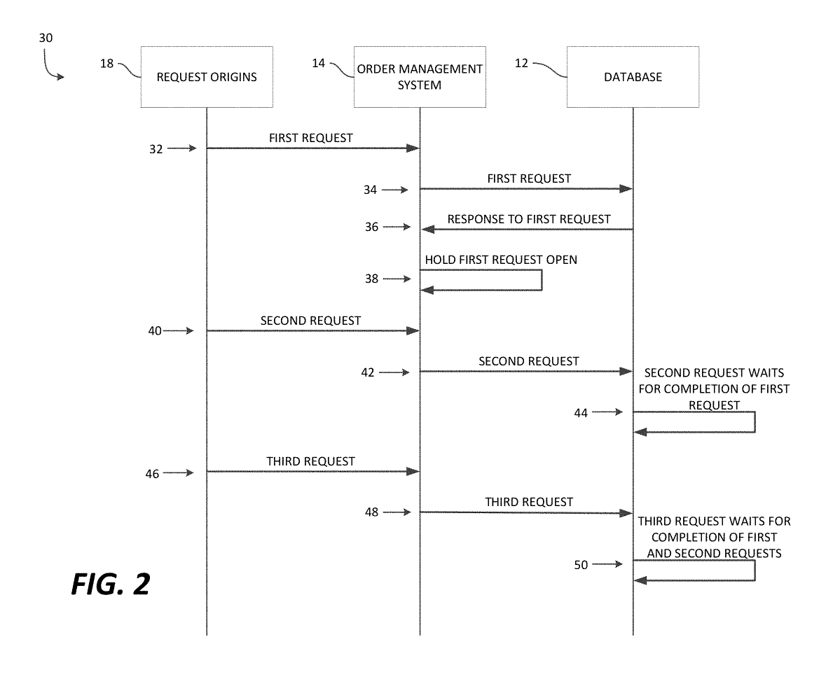

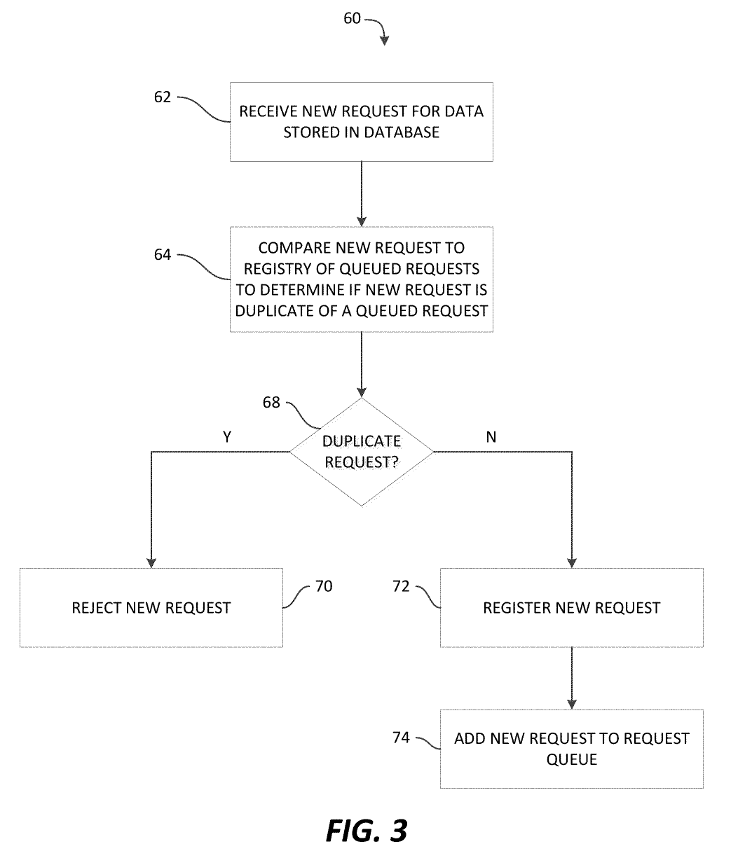

The request management system 16 may perform one or more steps, methods, or techniques that will be described below to improve upon native database functionality. For example, the request management system 16 may find use with the example methods of FIGS. 3-6. Before proceeding to a description of those methods, however, an example of request management that may be performed by a database itself will first be described with respect to FIG. 2 to illustrate how and why such functionality can be improved upon.

FIG. 2 is a sequence diagram illustrating an example request management method 30 that may be performed by a database 12. Specifically, the method 30 of FIG. 2 illustrates an example method 30 by which a database 12 may handle duplicate requests.

The method 30 of FIG. 2 may include a step 32 in which a request origin 18 may transmit a first request to the order management system 14. The method 30 may further include a step 34 in which the order management system may transmit the first request to the database 12. Upon receiving the first request, the database 12 may open a processing thread dedicated to the first request, in an embodiment.

The method 30 may further include a step 36 that may include the database 12 transmitting a response to the first request to the order management system 14. The response may include the information requested in the first request. For example, in an embodiment in which the request is request to recall information about an order to purchase one or more products, the response may be or may include the information about the order.

The method 30 may further include a step 38 in which the order management system may hold the request from the database 12 for further processing within the order management system 14. The database 12 may hold the processing thread dedicated to the request open until the order management system 14 completes its processing on the response.

While the database 12 holds a thread dedicated to one request (e.g., the first request of FIG. 2) open, it may prevent the database 12—according to the database's native programming—from handling certain further requests. In some embodiments, the database 12 may be prevented from handling further requests for information stored in the same block as the information sought in the first request, or some other portion of the database, until the open request is completed. In other embodiments, the database 12 may be prevented from handling further requests for information stored anywhere in the database 12 until the open thread is completed. This database functionality is known as a “blocking lock”—i.e., a portion of a database that is being accessed to service a request, or the entire database, is locked so as to block further requests from accessing the database or database portion.

The method 30 may further include a step 40 that may include a request origin 18 sending a second request to the order management system 14. The second request is a duplicate of the first request, which may have been sent in error. The method 30 may further include a step 42 that may include the order management system 14 transmitting the second request to the database 12. Upon receiving the second request, the database may open a processing thread dedicated to the second request.

In the example of FIG. 2, the first request has not yet completed when the database 12 receives the second request. Accordingly, the database 12 maintains the separate processing threads dedicated to the first request and the second request, with the second request waiting for the first request to complete before proceeding, as indicated at step 44.

The method 30 may further include steps 46, 48 that may include a request origin 18 sending a third request to the order management system 14, and the order management system 14 sending the third request to the database 12. The third request is also a duplicate of the first request, in the example of FIG. 2.

Upon receiving the third request, the database 12 may open a processing thread dedicated to the third request. Because the first request is still pending, the database maintains the separate processing threads dedicated to the first request, the second request, and the third request, with the second request thread waiting for the first request thread to complete before proceeding. Similarly, the third request must wait for the second request thread and the first request thread to complete before proceeding, as indicated at step 50.

The instant inventor has appreciated that the database functionality of FIG. 2 can be improved upon in several respects. First, the database 12 unnecessarily opens processing threads—with the associated use of computing resources—for the second and third requests, which were duplicates of the first request that were sent in error and thus do not require responses. Second, whether or not additional requests are duplicates, the dedicated processing threads for requests that the database cannot service due to a blocking lock for the first request occupy database computing resources. If many requests are received within a short period of time, database performance can be degraded. In embodiments, database performance may be degraded to a degree that the database crashes. Implementing a request management system according to the present disclosure may improve upon one or both of these issues, and may provide other benefits, in embodiments.

FIG. 3 is a flow chart illustrating an example method 60 of managing requests for information from a database before the requests are submitted to the database. One or more steps of the method 60 may be performed by a database request management system 16, in an embodiment. The method 60 will be described with reference also to the system of FIG. 1.

The method 60 may include a step 62 that may include receiving a new request for data stored in the database 12. The new request may be received by the request management system 16 from one or more entities, such as one of the request origins 18 of FIG. 1.

The method 60 may further include comparing the new request to a registry of queued requests that were previously made (step 64) to determine if the new request is a duplicate of any previous, queued request (step 68). The queued requests may be maintained in a request queue 26 of the request management system 16. Each of the queued requests may have been previous requests that were received and registered in the request registry 28 of the request management system 16, in addition to being added to the request queue 26.

Comparing the new request to the registry of queued requests may include comparing an identifier associated with the new request to identifiers stored in the registry 28 that are respectively associated with the queued requests.

Comparing the identifier associated with the new request to identifiers stored in the request registry 28 may provide an efficient means of determining whether the new request is a duplicate of a request pending for a response from database. Accordingly, if the new request identifier matches an identifier in the request registry, it may be determined that the new request is a duplicate of a queued request. Conversely, if the new request identifier does not match any identifier in the request registry 28, it may be determined that the new request is not a duplicate of any queued request.

As an alternative to comparing the identifier associated with the new request to identifiers stored in the request registry 28, the contents of the new request may instead be compared to one or more queued requests.

The method 60 may further include a step 70 in which the request management system 16 may reject the new request if the new request was determined to be a duplicate of a queued request. In an embodiment, rejecting the new request may include the request management system 16 transmitting an error message to the origin 18 of the new request—i.e., to the user, vendor, or other entity that transmitted the new request to the request management system 16.

The method 60 may further include a step 72 that may include registering the new request if it is not a duplicate request of a queued request in the registry 28 and a step 74 that may include adding the new request to the request queue 26. Registering the new request may include storing an identifier respective of the new request in the request registry 28, in an embodiment. Adding the new request to the request queue 26 may include adding the complete request to the end, or bottom, of the request queue 26, in an embodiment.

The steps of the method 60 may be performed for each new request that is received by the request management system 16. Accordingly, a plurality of new requests may be received by the request management system 16, and the request management system 16 may compare each new received request to requests that are registered in the request registry 28 of the data memory 24 to determine, for each received request, if the received request is a duplicate of a request that is registered in the data memory 24. In embodiments where the request registry 28 includes identifiers of queued requests, the comparison may also be used to determine if each new received request is a duplicate of any queued request. The request management system 16 may then reject each received request that is determined to be a duplicate of a request that is registered in the data memory 24 (and, in an embodiment, of a request that is in the request queue 26), and register, in the data memory 24, each received request that is determined not to be a duplicate of a request that is registered in the data memory 24 (and, in an embodiment, of a request that is in the request queue 26). Further, the request management system 16 may add each new request to the request queue 26 that is determined not to be a duplicate of a previous, queued and/or registered request.

As part of determining and rejecting duplicate requests, the request management system 16 may also track the origin 18 of duplicate requests, in an embodiment. As noted above, duplicate requests are often sent in error. Accordingly, tracking the origin 18 of duplicate requests may enable the request management system 16 to inform frequently-erroneous request origins 18 of the errors so that the errors can be addressed by the origin 18 itself, for example, among other benefits.

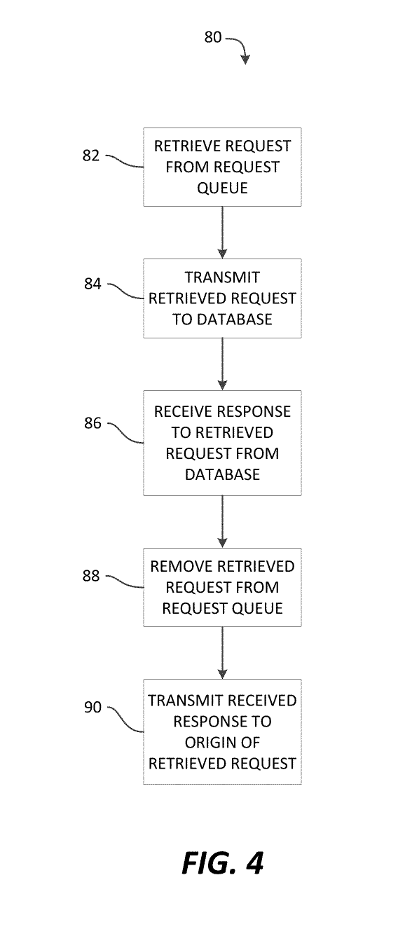

FIG. 4 is a flow chart that illustrates an example method 80 of queuing requests for information stored in a database 12 and providing queued requests to a database 12. Some or all of the steps of the method 80 may be performed by a request management system 16, in an embodiment. Like FIG. 3, FIG. 4 will be described also with reference to FIG. 1.

The method 80 may include a step 82 that may include retrieving a request from the request queue 26. The request may be retrieved from the “top” of the request queue 26, in an embodiment. As noted above, the request queue 26 may functionally be an ordered list of requests. The queue may be ordered from oldest to newest, in an embodiment, such that the oldest request in the queue is the next request to be provided to the database. Accordingly, in an embodiment, the “top” of the queue may refer to the oldest pending request in the queue 26, and the “bottom” of the queue may refer to the newest pending request in the queue 26. In another embodiment, requests may be ordered from top to bottom in the queue 26 according to some other determination of priority.

The method 80 may further include a step 84 that includes transmitting the retrieved request to the database 12. As noted above with respect to FIG. 1, in embodiments, the request management system 16 may transmit to the database 12 indirectly (e.g., through an order management system 14). In other embodiments, the request management system 16 may transmit to the database 12 directly.

The method 80 may further include a step 86 that may include receiving a response to the retrieved request from the database 12. As with transmitting the request, receiving the response may be accomplished through direct or indirect communications with the database 12, in embodiments.

The method 80 may further include a step 88 that may include removing the retrieved request from the request queue 26. In an embodiment, the retrieved request may be removed from the queue 26 after the response is received from the database 12. In another embodiment, removing the retrieved request from the request queue 26 may be accomplished at the time that the request is retrieved from the queue. Still further, in an embodiment, the request management system 16 may also remove the retrieved request (e.g., an identifier thereof) from the request registry 28.

Finally, the method 80 may include a step 90 that may include transmitting the response to the retrieved request to the origin 18 of the retrieved request.

In an embodiment, once the retrieved request has been transmitted to the origin 18 of the retrieved request, the method 80 may return to the retrieving step 82 to retrieve the queued request that has become the top request in the queue 26 as a result of removing the previously-retrieved request from the queue 26. The steps 82, 84, 86, 88, 90 of the method may thereafter repeat, continuously providing one request at a time to the database 12, so that database resources are not slowed or bogged down, in an embodiment.

The methods 60, 80 of FIGS. 3 and 4, or portions thereof, may be performed in parallel, in embodiments. That is, in an embodiment, the request management system 16 may handle new received requests according to the method 60 of FIG. 3, and may provide a sequence of requests to the database according to the method 80 of FIG. 4 in parallel processes.

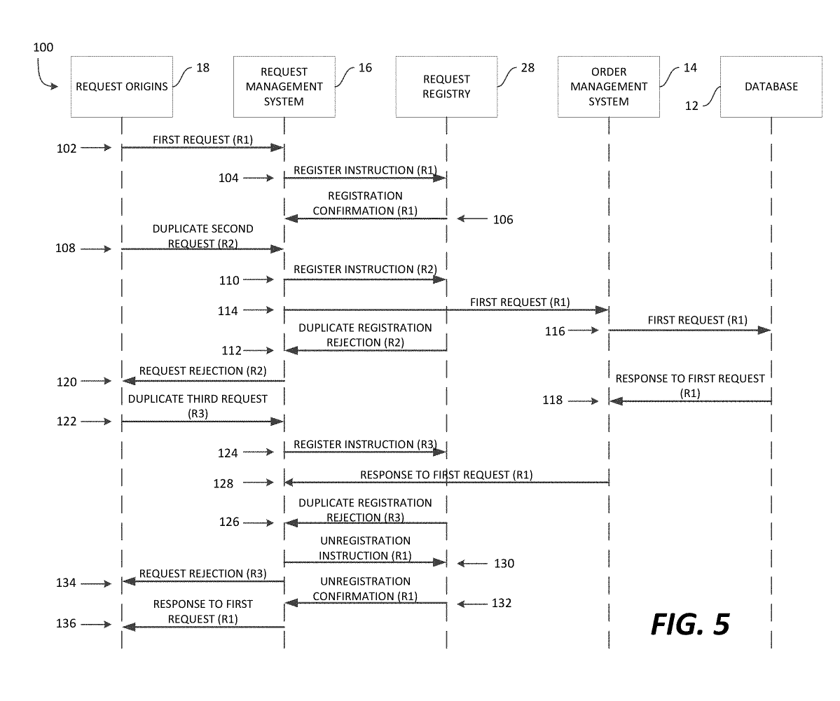

FIG. 5 is a sequence diagram illustrating an example request management process 100 that utilizes a request management system 16. The method 100 may provide an improvement in handling duplicate requests over the database-only functionality of FIG. 2. The method 100 of FIG. 5 elaborates upon several steps described with respect to FIGS. 3 and 4.

The method 100 may include a step 102 that includes a request origin 18 transmitting a first request to the request management system 16.

The method may further include the request management system 16 registering the first request in the data memory of the request management system (e.g., in the request registry 28 of the data memory). The registering may include a first sub-step 104 in which the request management system 16 transmits a registration instruction to the request registry 28. The registration request may include, in an embodiment, only the identifier respective of the first request. In another embodiment, the registration request may include the entirety of the request, or one or more portions of the request in addition to the identifier.

The request management system 16 may be configured to compare the first request to other registered requests to determine if the first request is a duplicate of any other registered request. As noted above with respect to FIG. 3, the request management system 16 may determine if a request is a duplicate by comparing its identifier to identifiers stored in the request registry 28. In the embodiment of the method 100 illustrated in FIG. 5, the first request is not a duplicate of any registered request.

The registering may further include a second sub-step 106 in which the request registry 28 transmits a registration confirmation respective of the first request to the request management system 16. The registration confirmation may confirm that the request registry 28 has stored the identifier respective of the first request.

It should be noted that the request management system 16 and the request registry 28 are shown as separate entities in FIG. 5 for ease of description only. As illustrated in and described with respect to FIG. 1, the request registry 28 may be a portion of data memory 24 within the request management system 16, in an embodiment. In other embodiments, however, the request registry 28 may be implemented in a physically separate entity from the processor 20 and program memory 22 of the request management system 16. For example, the request registry 28 may be implemented in a database (separate from the database 12) in electronic communication with the processor 20 of the request management system 16.

The registering may include storing an identifier respective of the request, in an embodiment. For example, in an embodiment in which the request is an instruction to recall or modify an order to purchase one or more products, the identifier may be respective of the order. Different requests may have different identifiers, in embodiments. As a result, in embodiments, each legitimate separate request may have a unique identifier to distinguish the request from other legitimate requests.

In an embodiment, the registering may include storing only the identifier in the data registry. That is, the details of the first request itself (and subsequent requests) may not be stored in the request registry, in an embodiment.

The method 100 may further include a step 108 in which a request origin 18 transmits a second request to the request management system 16. The second request is a duplicate of the first request which was likely sent in error.

The instant disclosure includes several instances in which duplicate requests—i.e., requests for the same information—are considered to be sent in error. It should be noted that duplicate requests may be legitimate, in some contexts. The instant disclosure is intended to address (among other things) multiple duplicate requests sent in quick succession, which the instant inventor has appreciated is indicative of erroneous behavior.

The method 100 may further include the request management system 16 attempting to register the second request. The attempted registration may include a first sub-step 110 in which the request management system 16 transmits a registration instruction to the request registry 28.

The request management system 16 may be configured to compare the second request to other registered requests to determine if the second request is a duplicate of any other registered request. In the embodiment of FIG. 5, the second request is a duplicate of the first request, which is registered in the request registry 28. Accordingly, the request management system 16 may determine that the second request is a duplicate request and, at a second sub-step 112 of the registration attempt, the request registry 28 may transmit a response to the registration instruction, which may include a registration denial message. At a further step 120, the request management system 16 may therefore reject the second request by transmitting an error message to the origin 18 of the second request. In an embodiment, the error message may inform the origin 18 that the second request is a duplicate.

The method 100 may further include a step 114 in which the request management system 16 may transmit the first request to the order management system 14. The method 100 may also include a step 116 in which the order management system 14 then transmits the first request to the database 12. In turn, at steps 118 and 128, the database 12 may transmit a response to the request to the order management system 14, and the order management system 14 may transmit the response to the request management system 16.

The sequence diagram of FIG. 5 also includes a third request that, like the second request, is a duplicate of the first request. It may go through a similar set of steps as the second request. Thus, at steps 122, 124, 126, and 134, the third request may be received by the request management system 16 from a request origin 18, the request management system 16 may transmit a registration instruction to the request registry 28, the request registry 28 may return a registration denial after determining that the third request is a duplicate of the registered first request, and the request management system 16 may reject the third request by transmitting an error message to the origin 18 of the third request.

The method 100 may also include the request management system 16, after receiving the response to the first request, may unregister the first request from the request registry 28. Unregistration may include a first sub-step 130 in which the request management system 16 may transmit an unregister instruction to the request registry 28. In response, at sub-step 132, the request registry 28 may remove the first request from the registry and may transmit an unregister response to the request management system 16 that confirms that the first request has been unregistered. Finally, at step 136, the request management system 16 may transmit the response to the request to the origin 18 of the first request.

The second and third requests were rejected in the method 100 because they were determined to be duplicates of the first request, while the first request was still pending—that is, while the first request was still registered in the request registry (which, in an embodiment, may also be indicative of the first request being present in a request queue). Accordingly, if the first request had been unregistered before the registration instruction for the third request was received by the request registry 28, for example, the third request would have been registered and processed, in an embodiment.

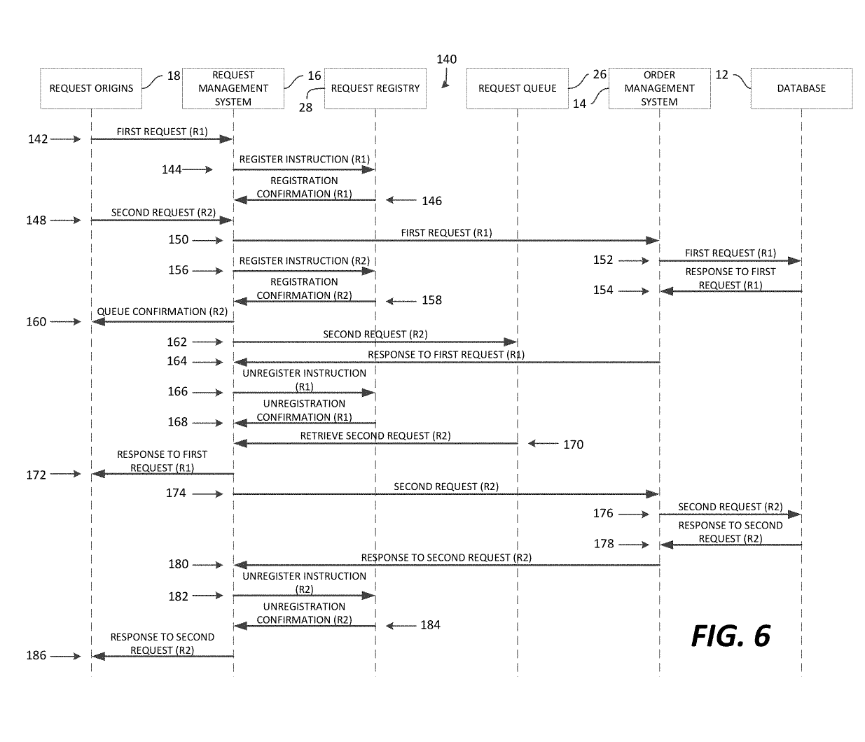

FIG. 6 is a sequence diagram illustrating an example method 140 of handling a queue of requests for information stored in a database with a request management system. For descriptive purposes, FIG. 6 will be illustrated and described with respect to an embodiment in which, at the beginning of the method 140, the request queue 26 and the request registry 28 are empty. Furthermore, for ease of description and illustration, FIG. 6 will be described with respect to an embodiment in which the request queue 26 and the request registry 28 are separate from the processor 20 of the request management system 16 and are in electronic communication with the request management system 16.

The method may include steps 142, 144, and 146 in which a first request may be received from a request origin 18 by the request management system 16, a registration instruction respective of the first request may be transmitted by the request management system 16 to the request registry 28, and the request registry 28 may transmit a registration confirmation to the request management system 16 after comparing a identifier of the first request to registered requests, determining that the first request is not a duplicate of any previous registered requests, and storing the identifier respective of the first request in the registry 28.

The method 140 may further include a step 148 in which the request management system may receive a second request from a request origin 18. In the embodiment illustrated in FIG. 6, the second request is not a duplicate of the first request.

The method 140 may further include the request management system registering the second request, including a first sub-step 156 in which the request management system 16 transmits a registration instruction respective of the second request to the request registry 28, and a second sub-step 158 in which the request registry returns a registration confirmation after determining that the second request is not a duplicate of any registered request and storing the identifier respective of the second request in the request registry 28.

The method 140 may further include a step 150 in which the request management system 16 may transmit the first request to the order management system 14 after determining that no requests are currently being processed by the database 12. In turn, at steps 152 and 154, the order management system 14 may transmit the first request to the database 12, and the database 12 may transmit a response to the first request to the order management system 14, which may include the data requested in the first request.

As illustrated in FIG. 6, the second request is received by the request management system 16 while the first request is still pending. Accordingly, after determining that a request (i.e., the first request) is still pending for processing by the database, the request management system 16 may, at step 160, transmit a message to the origin 18 of the second request to inform the origin 18 that the second request is being queued for processing. Further, at step 162, the order management system 16 may add the second request to the request queue 26 by transmitting the second request to the request queue 26.

In the embodiment of FIG. 6, the request queue 26 may add the second request to the empty request queue. Though not illustrated in FIG. 6, if further requests are received while the first request is still pending, the further requests may be registered in the request registry 28 and added to the request queue 26. In an embodiment, further requests that are added to the queue 26 may be added to the end of the queue in the order received.

The method 140 may further include a step 164 in which the order management system 14 transmits the response to the first request to the request management system 16. In response to receiving the response to the first request from the database 12, the request management system 16 may unregister the first request. Unregistration may include a first sub-step 166 in which the request management system 16 transmits an unregistration instruction respective of the first request to the request registry 28, and a second sub-step 168 in which the request registry 28 transmits an unregistration confirmation to the request management system 16. Finally, at step 172, the request management system 16 may transmit the response to the first request to the origin 18 of the first request.

In response to receiving the unregistration confirmation respective of the first request and/or receiving the response from the database 12 to the first request, the request management system 16 may determine that the database 12 is no longer handling a pending request. Accordingly, responsive to making that determination, at step 170, the request management system 16 may retrieve a queued request from the request queue 26. In an embodiment, the request management system 16 may retrieve the top queued request which, in the example of FIG. 6, is the second request.

After retrieving the second request from the request queue, the method 140 may proceed with respect to the second request as it did with respect to the first request. Accordingly, at step 174, the request management system 16 may transmit the second request to the order management system 14 and, at step 176, the order management system 14 may transmit the second request to the database 12. In turn, at steps 178 and 180, the database may provide a response to the second request to the order management system 14, and the order management system 14 may provide the response to the second request to the request management system 16. In response to receiving the response to the second request, the request management system 16 may unregister the second request and, at step 186, may transmit the response to the second request to the origin 18 of the second request. As noted above with respect to other unregistrations, unregistration may include a first sub-step 182 in which the request management system 16 transmits an unregistration instruction respective of the second request to the request registry 28, and a second sub-step 184 in which the request management system 16 receives an unregistration confirmation from the request registry 28 after the request registry removes the second request from the registry.

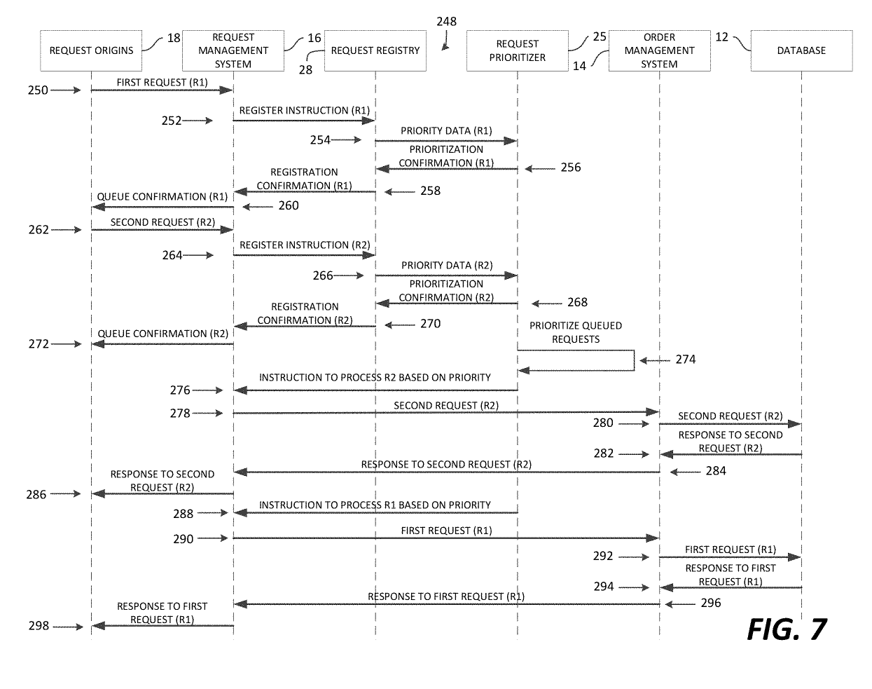

FIG. 7 is a sequence diagram illustrating an example method 248 of prioritizing requests and handling requests according to that priority. The method illustrates example prioritization functionality that may be applied by the request management system, in embodiments. FIG. 7 will be illustrated and described with respect to an embodiment in which, at the beginning of the method, the request queue 26 is empty, but in which an existing request is already being serviced by the database. Furthermore, for ease of description and illustration, FIG. 7 will be described with respect to an embodiment in which the request registry 28 and the request prioritizer 25 are separate from the processor 20 of the request management system 16 and are in electronic communication with the request management system 16. Although the request queue 26 is not shown in FIG. 7 for ease of illustration, the functionality of the request queue 26 will be referenced.

The method 248 may include steps 250, 252 in which a first request may be received from a request origin 18 by the request management system 16, and a registration instruction respective of the first request may be transmitted by the request management system 16 to the request registry 28. The registration instruction may include a priority associated with the first request. Accordingly, at a further step 254 the priority associated with the first request may be transmitted to the request prioritizer 25. After recording the priority associated with the first request, the request prioritizer 25 may transmit a prioritization confirmation respective of the first message at step 256, and the request registry 28 may transmit a registration confirmation respective of the first message after registering an identifier associated with the first request at step 258. The method may further include a step 260 in which a queue confirmation message is transmitted by the request management system 16 to the origin 16 of the first request.

The method 248 may further include steps 262, 264 in which a second request may be received from a request origin 18 by the request management system 16, and a registration instruction respective of the second request may be transmitted by the request management system 16 to the request registry 28. The registration instruction may include a priority of the second request. Accordingly, at a further step 266 the priority associated with the second request may be transmitted to the request prioritizer 25. After recording the priority associated with the second request, the request prioritizer 25 may transmit a prioritization confirmation respective of the second message at step 268, and the request registry 28 may transmit a registration confirmation respective of the second message after registering an identifier associated with the second request at step 270. The method may further include a step 272 in which the request management system 16 transmits a queue confirmation to the origin of the second request.

Although not illustrated in FIG. 7, the method 248 may additionally include steps for adding the first and second requests to the request queue 26, as described elsewhere in this disclosure. Queued requests may be presented to the database according to their priority, in embodiments.

The priority of a given request may depend on the content of the request, i.e., the type of information that the database 12 will return or alter when it is servicing the request. For example, requests related to payments may be given a different priority than a request to cancel an order, which may be given a different priority than a shipped confirmation from a shipping vendor.

In the example method 140 of FIG. 6, requests are ordered in the request queue 26 according to the sequence in which they are received from the request origins—i.e., older requests are placed “above” newer requests in the queue. In the example method 248 of FIG. 7, as will be described below, requests are ordered in the queue and/or retrieved from the queue according to their priority.

The method 248 may continue with a step 274 in which the request prioritizer orders the first and second requests according to their priority. In an embodiment, the ordering step 274 may occur after each individual request is received, wherein the request prioritizer may insert that request into the queue in the appropriate position. Alternatively, in an embodiment, the ordering step 274 may be omitted, and the request prioritizer may select a request to be transmitted to the database from the request queue according to the respective priorities of the queued requests at the time that a request from the queue needs to be provided to the database. That is, in an embodiment, the request prioritizer may parse the queue and select the highest-priority queued request for transmission to the database. In any of these example embodiments, the request prioritizer may be considered to order registered requests for transmission according to respective priorities associated with those requests.

In the example of FIG. 7, the second request has a higher priority than the first request.

The method 248 may further include a step 276 in which, after the database 12 completes its prior request, the request prioritizer 25 selects a request from the request queue and transmits that selection to the request management system 16, or instructs the request management system 16 to retrieve a particular request from the request queue. In the example of FIG. 7, as noted above, the second request has a higher priority than does the first request. Accordingly, at step 276, the request prioritizer selects the second request and sends an indication that the second request should be processed next to the request management system 16.

The method 248 may further include steps 278, 280 in which, responsive to the request prioritizer 25 selecting the second request as the highest-priority queued request, the request management system 16 may transmit the second request to the order management system 14, which may transmit the second request to the database 12 for processing. The method 248 may further include steps 282, 284, 286 in which the database 12 returns the information requested in the second request to the order management system 14, the order management system 14 forwards the response to the request management system 16, and the request management system 16 provides the requested information to the origin 18 of the second request.

The method 248 may further include a step 288 in which, after the database 12 completes servicing the second request, the request prioritizer 25 selects a request from the request queue and transmits that selection to the request management system 16 (or an indication of which request to retrieve). In the example of FIG. 7, the only other request in the request queue is the first request. Accordingly, at step 288, the request prioritizer 25 selects the first request and sends an indication that the first request should be processed next to the request management system 16.

The method 248 may further include steps 290, 292 in which the request management system may transmit the first request to the order management system 14, which may transmit the first request to the database 12 for processing. The method 248 may further include steps 294, 296, 298 in which the database 12 returns the information requested in the first request to the order management system 14, the order management system 14 forwards the response to the request management system 16, and the request management system 16 provides the requested information to the origin 18 of the first request.

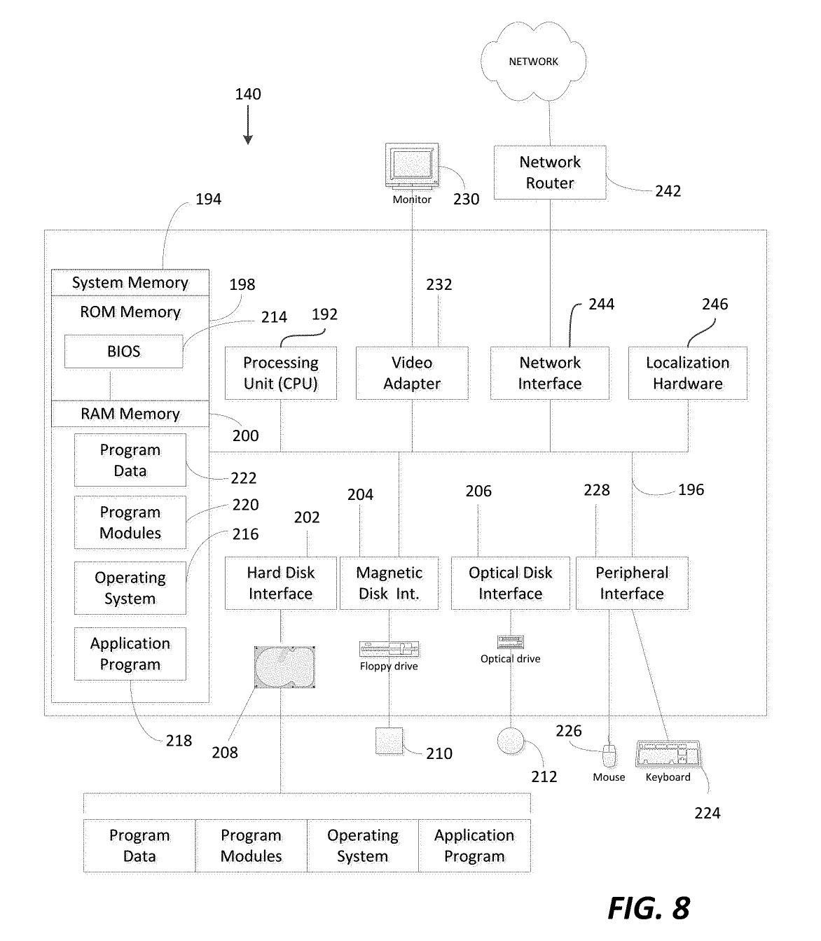

FIG. 8 is a diagrammatic view of an illustrative computing system that includes a general purpose computing system environment 190, such as a desktop computer, laptop, smartphone, tablet, or any other such device having the ability to execute instructions, such as those stored within a non-transient, computer-readable medium. Furthermore, while described and illustrated in the context of a single computing system 190, those skilled in the art will also appreciate that the various tasks described hereinafter may be practiced in a distributed environment having multiple computing systems 190 linked via a local or wide-area network in which the executable instructions may be associated with and/or executed by one or more of multiple computing systems 190.

In its most basic configuration, computing system environment 190 typically includes at least one processing unit 192 and at least one memory 194, which may be linked via a bus 196. Depending on the exact configuration and type of computing system environment, memory 194 may be volatile (such as RAM 200), non-volatile (such as ROM 198, flash memory, etc.) or some combination of the two. Computing system environment 190 may have additional features and/or functionality. For example, computing system environment 190 may also include additional storage (removable and/or non-removable) including, but not limited to, magnetic or optical disks, tape drives and/or flash drives. Such additional memory devices may be made accessible to the computing system environment 190 by means of, for example, a hard disk drive interface 202, a magnetic disk drive interface 204, and/or an optical disk drive interface 206. As will be understood, these devices, which would be linked to the system bus 196, respectively, allow for reading from and writing to a hard disk 208, reading from or writing to a removable magnetic disk 210, and/or for reading from or writing to a removable optical disk 212, such as a CD/DVD ROM or other optical media. The drive interfaces and their associated computer-readable media allow for the nonvolatile storage of computer readable instructions, data structures, program modules and other data for the computing system environment 190. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 190.

A number of program modules may be stored in one or more of the memory/media devices. For example, a basic input/output system (BIOS) 214, containing the basic routines that help to transfer information between elements within the computing system environment 190, such as during start-up, may be stored in ROM 198. Similarly, RAM 200, hard drive 208, and/or peripheral memory devices may be used to store computer executable instructions comprising an operating system 216, one or more applications programs 218 (such as the request management processes disclosed herein), other program modules 220, and/or program data 222. Still further, computer-executable instructions may be downloaded to the computing environment 190 as needed, for example, via a network connection.

An end-user, e.g., a customer, retail associate, and the like, may enter commands and information into the computing system environment 190 through input devices such as a keyboard 224 and/or a pointing device 226. While not illustrated, other input devices may include a microphone, a joystick, a game pad, a scanner, etc. These and other input devices would typically be connected to the processing unit 192 by means of a peripheral interface 228 which, in turn, would be coupled to bus 196. Input devices may be directly or indirectly connected to processor 192 via interfaces such as, for example, a parallel port, game port, firewire, or a universal serial bus (USB). To view information from the computing system environment 190, a monitor 230 or other type of display device may also be connected to bus 196 via an interface, such as via video adapter 232. In addition to the monitor 230, the computing system environment 190 may also include other peripheral output devices, not shown, such as speakers and printers.

The computing system environment 190 may also utilize logical connections to one or more computing system environments. Communications between the computing system environment 190 and the remote computing system environment may be exchanged via a further processing device, such a network router 242, that is responsible for network routing. Communications with the network router 242 may be performed via a network interface component 244. Thus, within such a networked environment, e.g., the Internet, World Wide Web, LAN, or other like type of wired or wireless network, it will be appreciated that program modules depicted relative to the computing system environment 190, or portions thereof, may be stored in the memory storage device(s) of the computing system environment 190.

The computing system environment 190 may also include localization hardware 186 for determining a location of the computing system environment 190. In embodiments, the localization hardware 246 may include, for example only, a GPS antenna, an RFID chip or reader, a WiFi antenna, or other computing hardware that may be used to capture or transmit signals that may be used to determine the location of the computing system environment 190.

The computing environment 190, or portions thereof, may comprise one or more of the request origins of FIG. 1. Additionally, or alternatively, the components of the computing environment 190 may comprise embodiments of the request management system 16, order management system 14, and/or database 12 of FIG. 1.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various embodiments of the present invention.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A system, comprising:
a database request management system configured to be in electronic communication with a database, the database request management system comprising:
a non-transitory computer-readable program memory storing instructions;
a non-transitory computer-readable data memory; and
a processor configured to execute the instructions to:
receive a new request for data stored in the database;
determine that the database is busy processing a previous request for data stored in the database;
store, in the data memory, the new request;
receive, from the database, a response to the previous request; and
in response to receiving the response to the previous request, transmit the new request to the database.

2. The system of claim 1, further comprising the database.

3. The system of claim 2, wherein the database is a non-relational database.

4. The system of claim 3, wherein the database is a NOSQL database.

5. The system of claim 1, wherein the processor is configured to execute the instructions further to:
receive the previous request for data stored in the database;
register the previous request in the data memory;
transmit the previous request to the database; and
unregister the previous request from the data memory after receiving the response to the previous request from the database;
wherein transmitting the new request to the database comprises transmitting the new request to the database after unregistering the previous request.

6. The system of claim 1, wherein the new request is a first new request, wherein the processor is configured to execute the instructions further to:
receive a second new request for data stored in the database;
compare the second new request to one or more requests that are registered in the database request management system;
determine that the second new request is a duplicate of one of the one or more requests that are registered in the database request management system; and
reject the second new request.

7. The system of claim 6, wherein rejecting the second new request comprises not transmitting the second new request to the database.

8. A system, comprising:
a database request management system configured to be in electronic communication with a plurality of users and with a database, the database request management system comprising:
a non-transitory computer-readable program memory storing instructions;
a non-transitory computer-readable data memory; and
a processor configured to execute the instructions to:
receive a plurality of requests for data stored in the database;
compare each received request to requests that are registered in the data memory to determine, for each received request, if the received request is a duplicate of a request that is registered in the data memory;
reject each received request that is determined to be a duplicate of a request that is registered in the data memory;
register, in the data memory, each received request that is not determined to be a duplicate of a request that is registered in the data memory; and
transmit each registered request to the database.

9. The system of claim 8, wherein transmitting each registered request to the database comprises:
transmitting a given one of the registered requests only after receiving a response from the database to the previously-transmitted registered request, such that only a single one of the registered requests is pending in the database at a time.

10. The system of claim 8, wherein the processor is configured to execute the instructions further to:
receive responses to the registered requests from the database; and
unregister each request for which a response has been received after receiving the response.

11. The system of claim 8, further comprising the database.

12. The system of claim 11, wherein the database is a non-relational database.

13. The system of claim 12, wherein the database is a NOSQL database.

14. The system of claim 8, wherein transmitting each registered request to the database comprises ordering registered requests for transmission according to respective priorities associated with the requests.

15. A system, comprising:
a database;
a database request management system in electronic communication with the database, the database request management system comprising:
a non-transitory computer-readable program memory storing instructions;
a non-transitory computer-readable data memory, the data memory storing a queue of requests for data from the database and a registry of queued requests; and
a processor configured to execute the instructions to:
(i) receive new requests for data stored in the database;
(ii) compare each of the new requests to the registry of queued requests to determine if each new request is a duplicate of a queued request;
(iii) reject each of the new requests that is determined to be a duplicate of a queued request;
(iv) add each new request that is determined not to be a duplicate of a queued request to the request queue;
(v) register each new request that is determined not to be a duplicate of a queued request in the registry; and
(vi) in parallel with (i)-(v), continuously transmit the top request from the queue of requests to the database, receive a response to the top request from the database, and remove the top request from the queue and unregister the top request from the request registry after receiving the response.

16. The system of claim 15, wherein (vi) comprises transmitting the received response to the top request to an origin of the top request.

17. The system of claim 15, wherein the database in a NOSQL database.

18. The system of claim 15, wherein the data memory comprises a first memory for the queue of requests and a separate second memory for the request registry.

19. The system of claim 15, wherein the database stores information respective of an inventory of a plurality of products and the requests comprise requests for information regarding orders to purchase one or more of the plurality of products.

20. The system of claim 15, wherein (iii) comprises transmitting an error message to an origin of the duplicate request.

21. The system of claim 15, wherein the processor is configured to execute the instructions further to store the identity of the origin of each duplicate request.
